(19) United States
(12) Patent Application Publication
(10) Pub. No.: US 2008/0018590 A1
(43) Pub. Date: Jan. 24, 2008

(54) SWITCH DEPLOY WITH DISPLAY LIFTING UNIT

(76) Inventor: Kuan-I Lin, Chiayi City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/458,493

(22) Filed: Jul. 19, 2006

(51) Int. Cl. G09G 5/00

(52) U.S. Cl. 345/156

(57) ABSTRACT

A switch deploy with display lifting unit has a display lifting unit, a display and a switch. The display lifting unit is controlled by the switch. The switch is integrated into an operation platform so that the display lifting unit is controlled directly by operating the operation platform.

### FIELD OF THE INVENTION

The present invention relates to display lifting units, in particular a display lifting unit being controlled by a switch with a circuit devise. The switch is integrated into an operation platform so that the display lifting unit is controlled directly by touching the operation platform. A user can prevent from a trouble for looking for the switch everywhere, when the user intends to control the display lifting or descending.

### BACKGROUND OF THE INVENTION

A display equipment for a general user is usually a computer display or television display. During the process of using, the display must be located on the table surface so as to be convenient for the user to view. Therefore, the display of prior arts must be occupied on the table surface. The prior arts may cause the problem that a display occupies the table surface whiling not using the display, even the display operation of embodiment of prior arts have no any problem. Besides, the display of prior arts may be damaged because of striking the display with force incautiously.

In order to deal with the above improper situation, a display lifting unit has been invented at the present so that the display can be installed in the display lifting unit to operate thereof. Whiling using, the display can be lifted and put on a table surface. On the other hand, whiling not using, the display can be hidden in the display lifting unit. The devise characters offer mush convenience for the user to operate the display. It not only has advantages of solving the problem that the display occupies the table surface, but also has advantages of reaching the goals for protecting and hiding the display. Therefore, the display lifting unit is very popular on the present market.

However, a switch is always fixed directly on the display lifting unit of the prior art. Therefore, the switch is installed in a specific location of the display lifting unit. Each time, a user must tend to the location of the switch for touching thereof to operate the display. It is not only inconvenient, but also taking-time so that the user is unsatisfied with these faults.

### SUMMARY OF THE INVENTION

The primary objective of the present invention is to provide a switch deploy with display lifting unit. The display lifting unit is controlled by the switch. The switch is integrated into an operation platform so that the display lifting unit is controlled directly by touching the operation platform. There are several advantages as the following descriptions.

Firstly, the switch of the display lifting unit is installed in the operation platform (the operation platform is a computer desk, if the embodiment is applied to operate a computer display; the operation platform is a sofa desk or a sofa handrail, if the embodiment is applied to operate a television display). Therefore, the present invention is capable surely of responding to the need of a user so as to control quickly the display lifting or descending. For instance, when the display lifting unit is applied in to operate the computer display, the switch of the display lifting unit can be installed in the keyboard frame of the computer desk (the proper position may be close to an accessing switch or a limit switch). Therefore, whiling a user pulls out a keyboard frame for operating a computer, the display is turned on and lifted up. On the other hand, whiling the user pushes into the keyboard frame, the display is descended and hidden so that the user can finish the process of computer shutting down quickly. Due to unnecessarily operate the display, it increases tremendously convenience and efficiency for the user. Besides, because a user is used to sit on a sofa to operate the television display, the switch deploy with display lifting unit of the present invention can prevent from a trouble that a user must stand up and reach to the television frame (the switch can be a remote controller for preventing from the problem of having a complex circuit between a display lifting unit and a sofa). Thereby, the user can operate the display lifting unit easily.

### BRIEF DESCRIPTION OF THE DRAWINGS

FIG. 1 is an outer view of the embodiment of the computer display of present invention.

FIG. 2 is illustrated with the operation of the present invention.

FIG. 3 is the other embodiment of the switch deploy of the present invention.

FIG. 4 is perspective view of the embodiment of the television frame of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

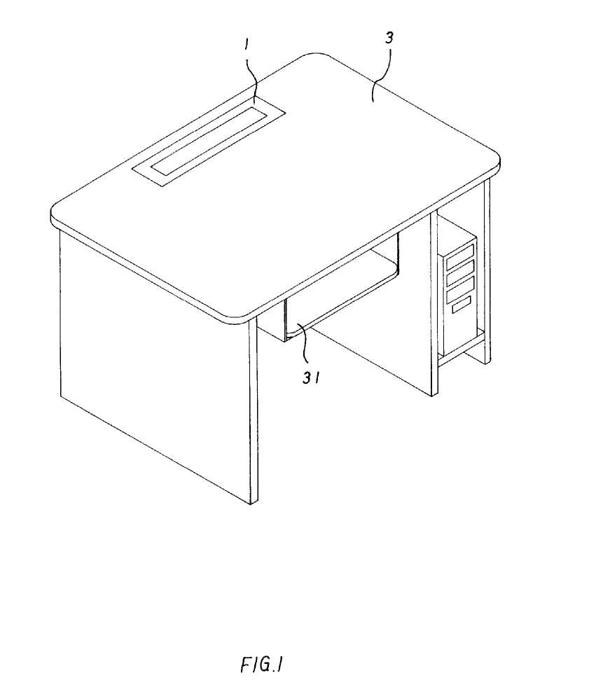

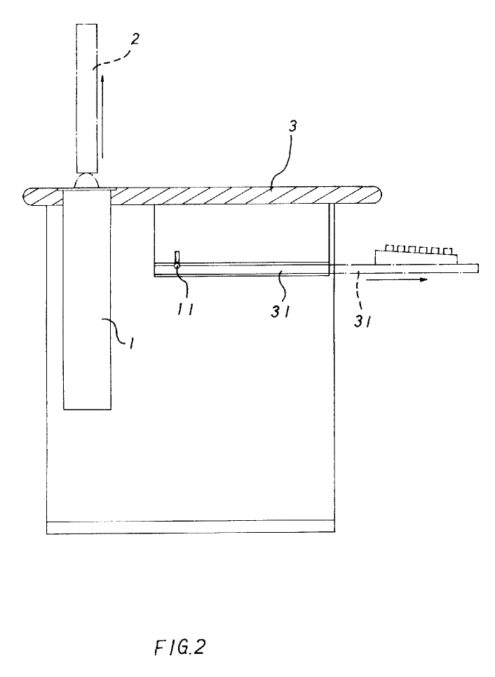

The switch deploy with display lifting unit of the present invention includes a display 2, a display lifting unit 1 and a switch 11. The display 2 is installed in the display lifting unit 1 capable of lifting and descending thereof (Referring to FIGS. 1 and 2). The display lifting unit 1 is controlled by a switch 11 by using of a switching mechanism disposed by circuits (the switch 11 can be a sensing type or a touch control type of prior arts). Besides, the switch 11 extends out to form an operation platform so as to integrate the switch 11 and the operation platform together.

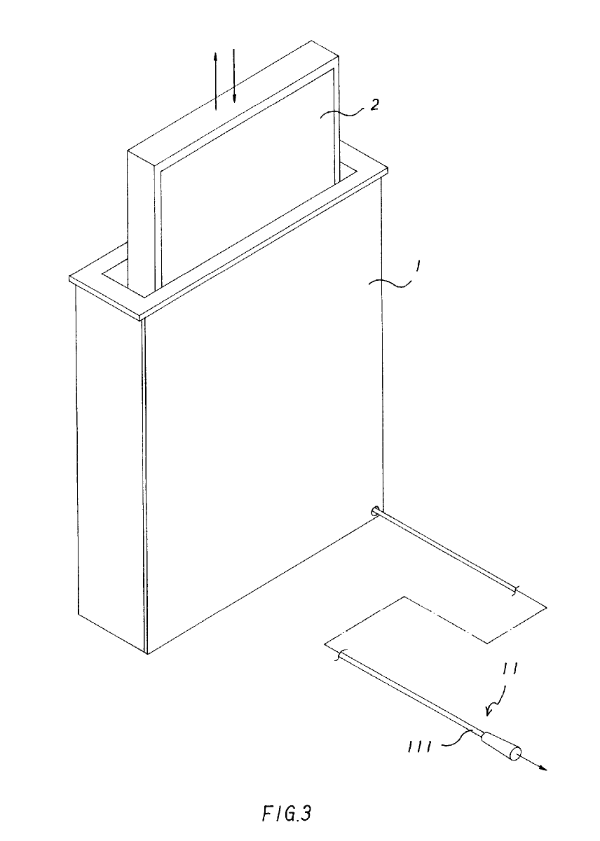

Therefore, when the display lifting unit 1 of the present invention is applied to operate a computer display 2, the operation platform of the display lifting unit 1 is a computer desk 3. So the switch 11 can be installed in a keyboard frame 31 of the computer desk 3. According to the position of the pulling and pushing the keyboard frame 31, the switch 11 is installed at a proper position (the proper position may be close to an accessing switch or a limit switch of prior arts of controlling switches). Therefore, when a user pulls the keyboard frame 31 out for operating a computer, the user can control the display lifting unit 1 of offering to lifting display 2 by using of turning on the switch 11. It is convenient for the user to operating the computer by utilizing the present invention. On the other hand, when the user finishes the computer operation, the switch 11 can sent out a controlling signal to descend the display 2 of the display lifting unit 1 by pushing the keyboard frame 31. As the illustrated with FIG. 3, a descending signal is sent out when a limit switch is touched. On the other hand, the lifting signal is sent out, when the limit switch does not be touched. Otherwise, the user can pull an exposure pull rope 111 extending from the display lifting unit 1 to pull the display 2 (referring to FIG. 3) so as to change the signal of the switch 11 at each pulling the pull rope 111. It is not only convenient for a user to control the display lifting unit 1, but also prevents from users trouble of searching the switch 11 everywhere.

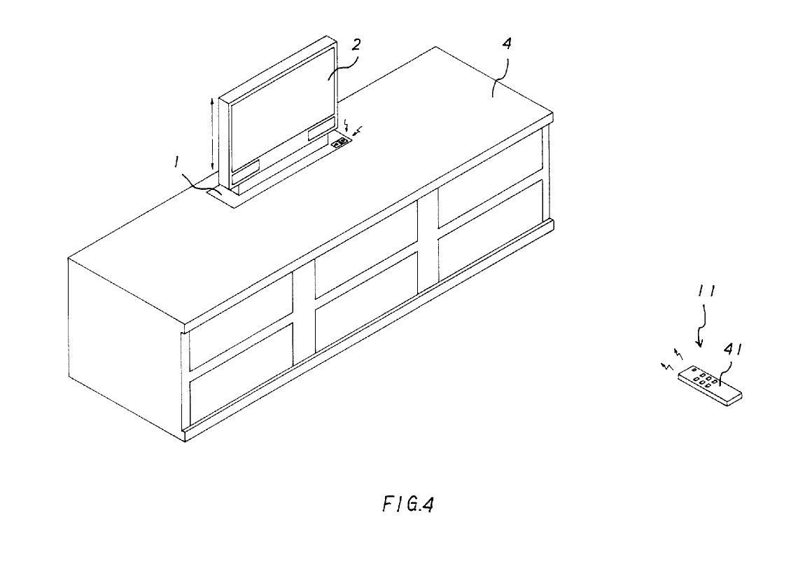

Besides, the display 2 of the embodiment of the present invention is installed in a television frame 4. Because a TV user is used to turn on a TV remote controller for watching the TV whiling sitting on a sofa, an operation platform can not be installed in a proper position of the sofa. Besides, the operation platform can be integrated into the remote controller 41. Referring to FIG. 4, the remote controller 41 can be integrated into a key setting of the TV remote controller or be manufactured independently. Therefore, the user can avoid the trouble to move herself/himself towards to the television frame 4. Besides, it prevents from a problem that the display lifting unit 1 must be installed a complex circuit with the sofa so that the user can operate all of these devices easily.

Therefore, the deployment of the switch 11 of the display lifting unit 1 is very important for a user to operate the lifting and descending display conveniently. However, the prior arts are ignored the deployment. The novel present invention will increase tremendously convenience so as to reach the goal of user friendly.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A switch deploy with display lifting unit comprising:
a display lifting unit;
a display;
a switch;
the display lifting unit being installed the display so as to operate the display lifting and descending; the switch extending out a device so as to be integrated into a operation platform.

2. The switch deploy with display lifting unit as claimed in claim 1, wherein the switch is integrated into a remote controller.
